(19) United States
(12) Patent Application Publication
(10) Pub. No.: US 2014/0152591 A1
(43) Pub. Date: Jun. 5, 2014

(54) ELECTRONIC DEVICE AND COMPUTER PROGRAM PRODUCT

(71) Applicant: Kabushiki Kaisha Toshiba, Tokyo (JP)

(72) Inventor: Satoshi Odakura, Tokyo (JP)

(73) Assignee: Kabushiki Kaisha Toshiba, Tokyo (JP)

(21) Appl. No.: 14/010,251

(22) Filed: Aug. 26, 2013

Related U.S. Application Data
(63) Continuation of application No. PCT/JP2013/064137, filed on May 15, 2013.

(30) Foreign Application Priority Data
Nov. 30, 2012 (JP) 2012-262526

(51) Int. Cl. G06F 3/0484; G09G 5/00

(52) U.S. Cl. CPC G06F 3/0484; G09G 5/006
USPC 345/173

(57) ABSTRACT

According to one embodiment, an electronic device includes a display device, a touch sensor, an account switching module, and a display controller. The display device includes a display screen. The touch sensor is configured to detect an operation on a display screen side of the display device. The account switching module is configured to switch a logged-in account from a second account which is lower than a first account to the first account when a detection result of the touch sensor corresponds to a pinch-in operation, and to switch the logged-in account from the first account to the second account when the detection result of the touch sensor corresponds to a pinch-out operation. The display controller is configured to control the display device so as to display an image on the display screen.

### CROSS-REFERENCE TO RELATED APPLICATIONS

This application is a continuation of PCT international application Ser. No. PCT/JP2013/064137, filed May 15, 2013, which designates the United States, incorporated herein by reference, and which is based upon and claims the benefit of priority from Japanese Patent Application No. 2012-262526, filed Nov. 30, 2012, the entire contents of which are incorporated herein by reference.

### FIELD

Embodiments described herein relate generally to an electronic device and a computer program product.

### BACKGROUND

Recently, there has been known an electronic device that detects a pinch-in operation or pinch-out operation through a touch panel to reduce or enlarge an image displayed on a display screen.

With such type of device, it is convenient if the pinch-in operation and pinch-out operation can be used more favorably.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external view of one example of an electronic device according to a first embodiment;

FIG. 2 is an exemplary block diagram of one example of the electronic device in the first embodiment;

FIG. 3 is an exemplary schematic diagram of hierarchized accounts of one example of the electronic device in the first embodiment;

FIG. 4 is an exemplary flowchart of one example of an account switching process of one example of the electronic device in the first embodiment;

FIG. 5 is an exemplary schematic diagram of one example of a change in a display screen in accordance with a pinch-in operation in one example of the electronic device in the first embodiment;

FIG. 6 is an exemplary schematic diagram of one example of a change in a display screen in accordance with a pinch-out operation in one example of the electronic device in the first embodiment;

FIG. 7 is an exemplary flowchart of one example of an account switching process in one example of an electronic device according to a second embodiment;

FIG. 8 is an exemplary schematic diagram of one example of a change in a display screen in accordance with a pinch-in operation or pinch-out operation in one example of the electronic device in the second embodiment;

FIG. 9 is an exemplary block diagram of one example of an electronic device according to a third embodiment;

FIG. 10 is an exemplary flowchart of one example of an account switching process in one example of the electronic device in the third embodiment;

FIG. 11 is an exemplary schematic diagram of one example of a change in a display screen in accordance with a pinch-in operation or pinch-out operation in one example of the electronic device in the third embodiment;

FIG. 12 is an exemplary block diagram of one example of an electronic device according to a fourth embodiment;

FIG. 13 is an exemplary flowchart of one example of an account switching process in one example of the electronic device in the fourth embodiment;

FIG. 14 is an exemplary schematic diagram of one example of a change of a display screen in accordance with a pinch-in operation or pinch-out operation in one example of the electronic device in the fourth embodiment;

FIG. 15 is an exemplary block diagram of one example of an electronic device according to a fifth embodiment;

FIG. 16 is an exemplary flowchart of one example of an account switching process in one example of the electronic device in the fifth embodiment;

FIG. 17 is an exemplary block diagram of one example of an electronic device according to a sixth embodiment;

FIG. 18 is an exemplary flowchart of one example of an account switching procedure in one example of the electronic device in the sixth embodiment;

FIG. 19 is an exemplary diagram illustrating one example of a specific area set in one example of an electronic device according to a seventh embodiment;

FIG. 20 is an exemplary flowchart of one example of a displayed image switching process in one example of an electronic device according to an eighth embodiment;

FIG. 21 is an exemplary flowchart of one example of an account switching process in one example of an electronic device according to a ninth embodiment;

FIG. 22 is an exemplary block diagram of one example of an electronic device according to a tenth embodiment;

FIG. 23 is an exemplary schematic diagram of hierarchized pieces of data in one example of the electronic device in the tenth embodiment;

FIG. 24 is an exemplary flowchart of one example of a displayed image switching process in one example of the electronic device in the tenth embodiment;

FIG. 25 is an exemplary schematic diagram of one example of a change in a display screen in accordance with a pinch-in operation in one example of the electronic device in the tenth embodiment;

FIG. 26 is an exemplary schematic diagram of one example of a change in a display screen in accordance with a pinch-out operation in one example of the electronic device in the tenth embodiment;

FIG. 27 is an exemplary schematic diagram of hierarchized pieces of data in one example of an electronic device according to a first modification of the tenth embodiment;

FIG. 28 is an exemplary schematic diagram of one example of a change in a display screen in accordance with a pinch-in operation or pinch-out operation in one example of an electronic device in the first modification;

FIG. 29 is an exemplary schematic diagram of hierarchized pieces of data in one example of an electronic device according to a second modification of the tenth embodiment; and

FIG. 30 is an exemplary schematic diagram of one example of a change in a display screen in accordance with a pinch-in operation or pinch-out operation in one example of the electronic device in the second modification.

### DETAILED DESCRIPTION

In general, according to one embodiment, an electronic device comprises: a display device, a touch sensor, an account switching module, and a display controller. The display device comprises a display screen. The touch sensor is configured to detect an operation on a display screen side of the display device. The account switching module is configured to switch a logged-in account from a second account which is lower than a first account to the first account when a detection result of the touch sensor corresponds to a pinch-in operation, and to switch the logged-in account from the first account to the second account when the detection result of the touch sensor corresponds to a pinch-out operation. The display controller configured to control the display device so as to display an image on the display screen.

A plurality of exemplary embodiments below comprise similar configuration elements. Those similar configuration elements will be hereinafter referred to by common reference numerals, and a redundant description will be omitted.

Although embodiments and modifications below exemplify cases in which an electronic device is configured as a personal computer, the electronic device according to the embodiments is not limited thereto. The electronic device according to the embodiments may be configured as a variety of electronic devices having a touch panel (a touch sensor), such as a smartphone, a cellular phone, a personal digital assistance (PDA), an electronic dictionary device, an image display device, a videophone, and a soft-keyboard-equipped display device.

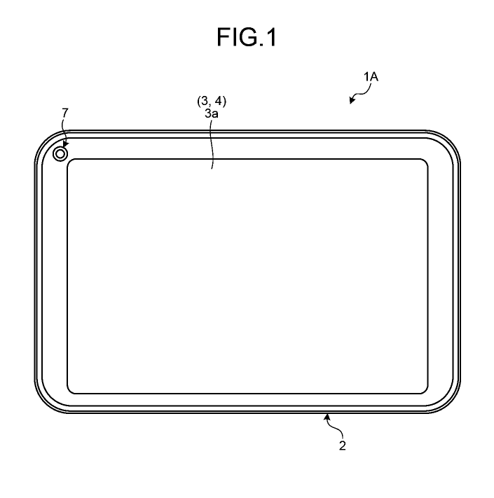

In a first embodiment, as an example, as illustrated in FIG. 1, an electronic device 1A is configured as a tablet (slate) personal computer. The electronic device 1A comprises a housing 2, a display device 3, a touch panel 4 (touch sensor), and a camera module 7. The housing 2 houses circuit boards and electronic components (both not illustrated; components, electric components) and the like. The housing 2 supports the display device 3. The display device 3 comprises a display screen 3a. The display device 3 is supported by the housing 2 in a state (attitude) allowing the display screen 3a to be visually recognized. As an example, a portion of the display device 3 is housed within the housing 2. The display device 3 is, for example, a liquid crystal display (LCD) or an organic electro-luminescent display (OELD). The display device 3 may be a flexible display (sheet display). The touch panel 4 is, as an example, configured as a thin colorless transparent panel and is positioned on the front side (the surface side, the front surface side) of the display screen 3a. The touch panel 4 can detect the presence or absence of an operation (pressing operation) on the display screen 3a side of the display device 3, an operation position, and the like. The touch panel 4 may be configured as an in-cell touch panel integrated with the display device 3. The camera module 7 (image pickup module) comprises, for example, a digital camera incorporating an image pickup device such as a charge coupled device (CCD) or a CMOS image sensor (CIS).

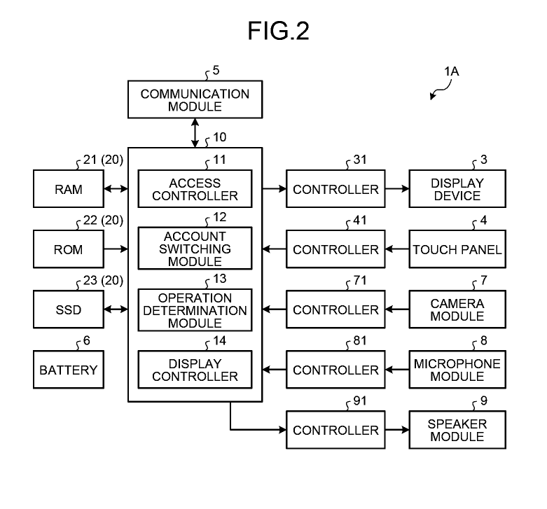

In the present embodiment, as an example, as illustrated in FIG. 2, the electronic device 1A comprises a main controller 10, an access controller 11, an account switching module 12, an operation determination module 13, a display controller 14, a storage module 20 (a random access memory (RAM) 21, a read only memory (ROM) 22, and a solid state drive (SSD) 23), controllers 31, 41, 71, 81, 91, the display device 3, the touch panel 4, a communication module 5, a battery 6, the camera module 7, a microphone module 8, a speaker module 9, and the like. The electronic device 1A may comprise a hard disk drive (HDD) as the storage module 20.

The main controller 10 is, for example, a central processing unit (CPU). The main controller 10 can perform various pieces of processing and control by reading and executing software programs installed in a nonvolatile storage module (for example, the ROM 22 or the SSD 23) of the electronic device 1A. In the present embodiment, as an example, the main controller 10 can function (operate) as the access controller 11, the account switching module 12, the operation determination module 13, the display controller 14, or the like. The RAM 21 stores therein various pieces of data temporarily while the main controller 10 performs processing and control.

The controller 31 is controlled by the main controller 10 and controls the display device 3 to allow an image (video) to be displayed on the display screen 3a. The controller 41 receives detection data from the touch panel 4 and sends it to the main controller 10. The controller 71 receives image data from the camera module 7 (image pickup module, camera) and sends it to the main controller 10. The controller 81 receives sound data from the microphone module 8 (voice input module, microphone) and sends it to the main controller 10. The controller 91 is controlled by the main controller 10 and controls the speaker module 9 (speaker) to emit a sound.

The communication module 5 can perform communication with an external device (not illustrated). The communication module 5 transmits data received from the main controller 10 to the external device and transmits data received from the external device to the main controller 10. The battery 6 (battery module, battery pack, assembled battery) supplies the modules of the electronic device 1A with power.

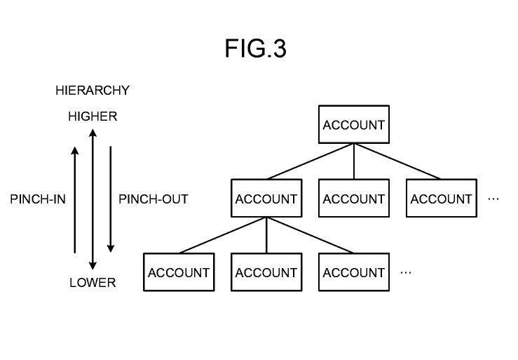

In the present embodiment, as an example, it is assumed that an account hierarchy (master-slave relation, dependency, inclusion, or category) of a plurality of accounts in which a plurality of accounts are hierarchically associated is set as illustrated in FIG. 3. As an example, an account at a low level (small category) (hereinafter referred to as lower account) is a personal account assigned to a person; an account at the next higher level (large category) (hereinafter referred to as higher account) is a group account assigned to a group to which persons belong; a further higher account is a department account assigned to a department to which groups belong. Such account hierarchy of the accounts can be applied to various communities such as families and friendship relations, not limited to corporate organizations. Such account hierarchization has an advantage that, as an example, being logged in to a lower account is also regarded as being logged in to a higher account corresponding to the lower account, thereby omitting a process (account verification) for logging into the higher account. There is another advantage that, as an example, authorization setting can be performed more easily with authorization set for each level than in a case with all authorizations set individually for each account. As an example, a possible authorization setting is that the authorization of the higher account is given to the lower account, whereas the authorization of the lower account is not given to the higher account.

Although FIG. 3 exemplifies a state in which a plurality of lower accounts are set for each account, a plurality of higher accounts also can be set for each account. For example, when a person belongs to a plurality of groups, the account of the person can be set for an account under the accounts of the groups. Data indicating the hierarchy of a plurality of accounts (for example, data indicating the correlation between a plurality of account IDs) is stored in the storage module 20 (for example, the SSD 23), the external device (administrative server), or the like.

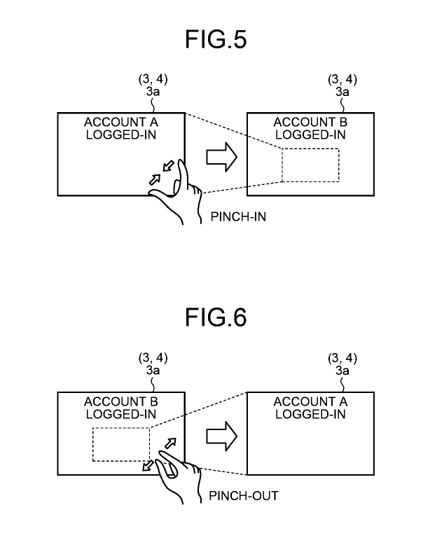

In the present embodiment, as an example, as illustrated in FIGS. 5 and 6, a logged-in account is switched from the lower account to the higher account through the pinch-in operation (input) on the touch panel 4, while the logged-in account is switched from the higher account to the lower account through the pinch-out operation (input) on the touch panel 4. The pinch-out operation is an operation to increase the separation between fingers, thereby it is easy to imagine that such operation corresponds to a shift (switching) from the higher account to the lower account, which is one of a plurality of lower accounts set corresponding to the higher account. In FIGS. 5 and 6, the account A is the lower account, and the account B is the higher account to which the account A belongs. Login is performed based on an account ID. Login processing (account verification) is, therefore, not performed at when an account is switched by the pinch-in operation or pinch-out operation as illustrated in FIG. 5 or 6, when both the higher account and the lower account has already been logged in (account verified) or when at least the lower account has already been logged in (account verified), for example.

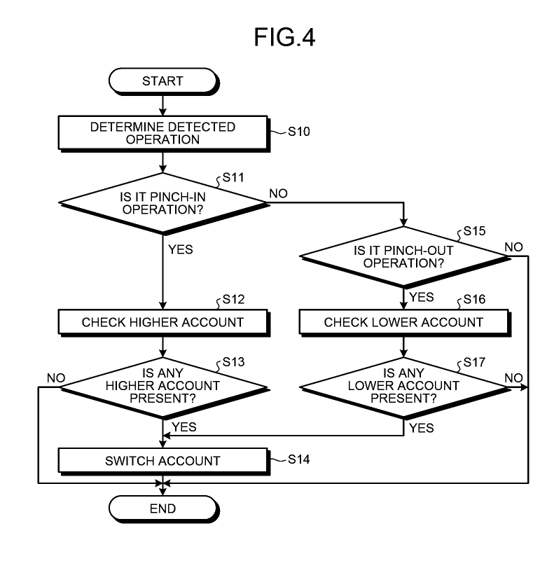

For the account switching, for example, as illustrated in FIG. 4, the main controller 10 first functions as the operation determination module 13 and determines whether the data corresponding to a detection result on the touch panel 4 is data corresponding to a pinch-in operation or data corresponding to a pinch-out operation (S10). In the pinch-in operation, contact or pressing is detected at two positions, and the two detection positions move while approaching (or approach) each other. In the pinch-out operation, contact or pressing is detected at two positions, and the two detection positions move while departing (or depart) from each other. At S10, the operation determination module 13 compares the movement mode (movement pattern, shape, magnitude, direction, angle, and the like) of the two detection positions with the movement mode (movement pattern, shape, magnitude, direction, angle, and the like) stored in the storage module 20 (for example, the ROM 22), thereby determining whether the movement mode of the two detection positions is one corresponding to the pinch-in operation or one corresponding to the pinch-out operation.

When the change in the two detection positions is one corresponding to the pinch-in operation at S11 (Yes at S11), the main controller 10 functions as the account switching module 12 and checks the presence or absence of any higher account corresponding to the current account in the storage module 20 or the external device (S12). The account switching module 12 makes an inquiry of the presence or absence of the account to the external device. When the higher account is present at S12 (Yes at S13), the main controller 10 functions as the account switching module 12 and switches the current account to the corresponding higher account (S14). After S14, the access controller 11 performs access control with a condition (authorization) set for the switched higher account.

When the change in the two detection positions is not one corresponding to the pinch-in operation at S11 (No at S11) but one corresponding to the pinch-out operation (Yes at S15), the main controller 10 functions as the account switching module 12 and checks the presence or absence of any lower account corresponding to the current account in the storage module 20 or the external device (S16). When the lower account is present at S12 (Yes at S17), the main controller 10 functions as the account switching module 12 and switches the current account to the corresponding lower account (S14). After S14, the access controller 11 performs access control with a condition (authorization) set for the switched lower account. In the case of No at S13 and in the case of No at S17, the procedure in FIG. 4 is ended.

In the present embodiment, as an example, when the account is switched at S14, the display controller 14 can control the display device 3 to change an image displayed on the display screen 3a in such a manner as exemplified in FIGS. 5 and 6. As illustrated in FIG. 5, when the logged-in account is switched from the lower account A to the higher account B in accordance with the pinch-in operation, the display controller 14 reduces with time (gradually decreases) a size of at least a portion of an image displayed at a time when the lower account A is logged in, displays an area of an image displayed at a time when the account B is logged in around the reduced image of the account A, and finally, deletes and switches the reduced image of the account A to the image of the account B. As illustrated in FIG. 6, in the case when the logged-in account is switched from the higher account B to the lower account A in accordance with the pinch-out operation, the display controller 14 enlarges with time (gradually enlarges) a size of at least a portion of an image displayed at a time when the account B is logged in so that the image of the account B is to be disappear, while replacing the enlarged image of the account B with the image of the account A, and finally switches the enlarged image of the account B to the image of the account A. The foregoing control allows a user to recognize the switching of accounts more easily. Image data or the like for use in (the processing of) the above-described display control can be stored in the storage module 20 (for example, the ROM 22 or the SSD 23).

As described above, in the present embodiment, as an example, the account switching module 12 switches the logged-in account from the lower account to the higher account in accordance with the pinch-in operation, and switches the logged-in account from the higher account to the lower account in accordance with the pinch-out operation. The present embodiment therefore can achieve, as an example, a new user interface utilizing the pinch-in operation or pinch-out operation. The switching of logged-in account can be achieved by a relatively simple operation that is the pinch-in operation or the pinch-out operation.

In the present embodiment, as an example, in the pinch-in operation, the display controller 14 controls the display device 3 so that a size of at least a portion of a pre-switching image is reduced. In the pinch-out operation, as an example, the display controller 14 controls the display device 3 so that a size of at least a portion of a pre-switching image is enlarged. The present embodiment, therefore, as an example, allows the switching of logged-in account to be easily visually recognized.

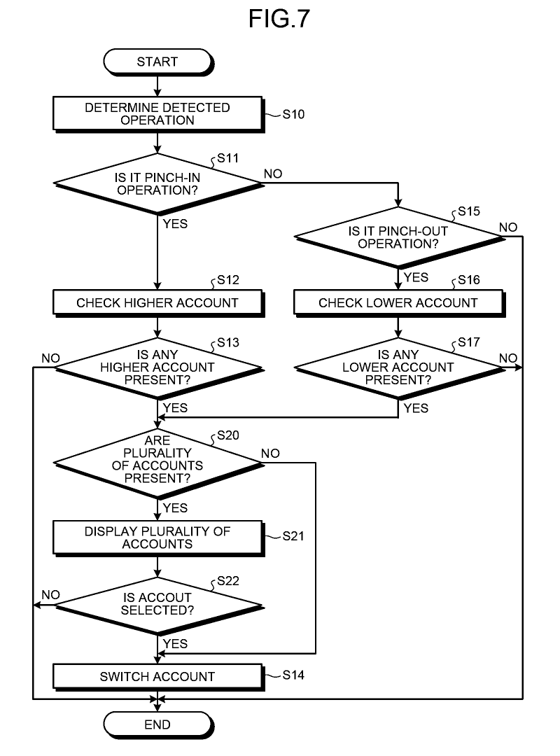

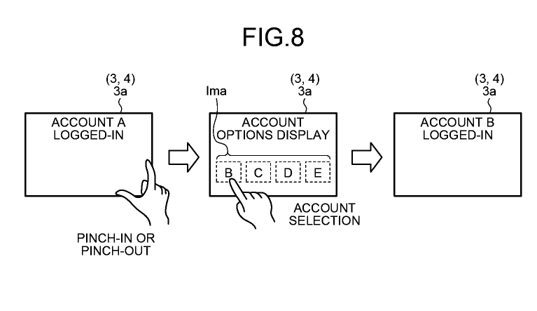

An electronic device according to a second embodiment comprises a similar configuration to that of the above-described embodiment, performs similar processing (control), and achieves a similar action and result (effect) based on the similar configuration and similar processing. The present embodiment exemplifies a selection method when a plurality of higher or lower accounts corresponding to a current account are present. Specifically, as illustrated in FIG. 7, when any higher or lower account corresponding to the current account is present (Yes at S13 or Yes at S17), and when a plurality of further higher or lower accounts are present (Yes at S20), the display controller 14, as illustrated in FIG. 8, controls the display device 3 so that a plurality of images Ima corresponding to a plurality of accounts as switching candidates (for example, icons and letters), respectively, are displayed on the display screen 3a (S21). After S21, when the operation determination module 13 determines that any one of the images Ima has been selected through an operation (input) by a user (Yes at S22), the account switching module 12 switches the logged-in account from the current account to the account selected at S22 (S14). The present embodiment, therefore, as an example, allows the user to easily select any one of the accounts corresponding to the current account while watching the display screen 3a. When only one higher or lower candidate account corresponding to the current account is present (No at S20), as is the case with the above-described embodiment, the account switching module 12 switches the logged-in account from the current account to the candidate account. In the case of No at S22, the procedure in FIG. 7 is ended.

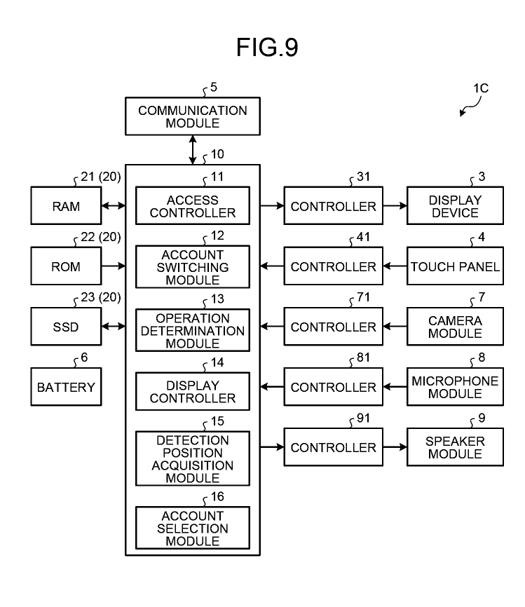

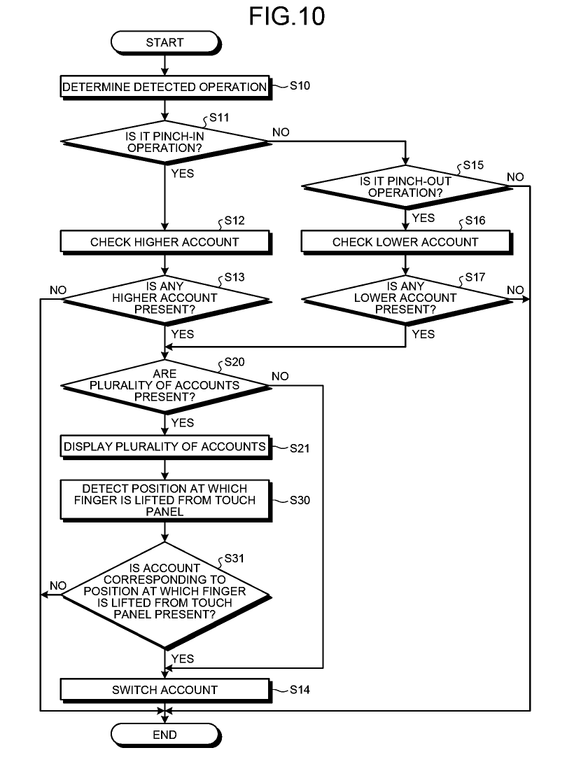

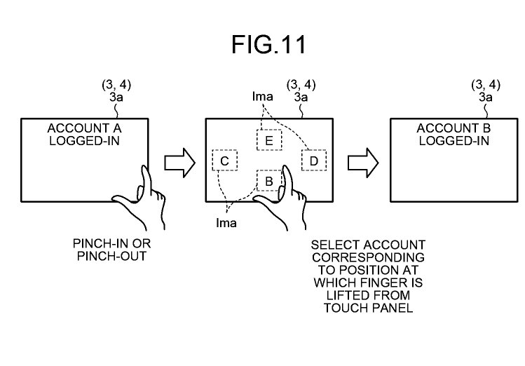

An electronic device 1C according to a third embodiment comprises a similar configuration to those of the above-described embodiments, performs similar processing (control), and achieves a similar action and result (effect) based on the similar configuration and similar processing. The present embodiment exemplifies a selection method when a plurality of higher or lower accounts corresponding to a current account are present. Specifically, as illustrated in FIG. 9, in the present embodiment, as an example, the main controller 10 further functions as a detection position acquisition module 15 and an account selection module 16. As illustrated in FIG. 10, when any higher or lower account corresponding to the current account is present (Yes at S13 or Yes at S17), and when a plurality of further higher or lower accounts are present (Yes at S20), the display controller 14, as illustrated in FIG. 11, controls the display device 3 so that a plurality of images Ima corresponding to a plurality of accounts as switching candidates (for example, icons and letters), respectively, are displayed on the display screen 3a (S21). Next, the main controller 10 functions as the detection position acquisition module 15 and detects, based on the detection result on the touch panel 4, a position (a detection position) at which a finger is lifted (the user has moved the finger off) from the touch panel 4 in the operation (input) by the user, that is, the ending position of the pinch-in operation or the pinch-out operation by the user (S30). Next, the main controller 10 functions as the account selection module 16 and compares the position detected at S30 at which the finger is lifted from the touch panel 4 with the position of the images Ima corresponding to the accounts. As an example, when the position at which the finger is lifted from the touch panel 4 is included in the area of the images Ima or the area including the images Ima and their surroundings (Yes at S31), the account of the images Ima is selected (determined) as an account to be switched to (to S14). The present embodiment, therefore, as an example, allows the user to easily select any one of the accounts corresponding to the current account while watching the display screen 3a. In the case of No at S31, the procedure in FIG. 10 is ended.

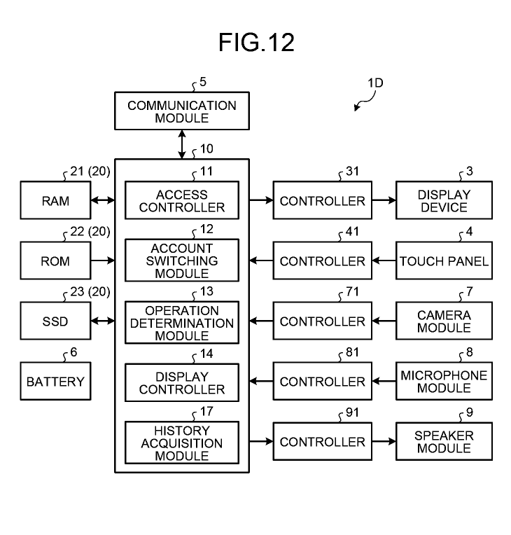

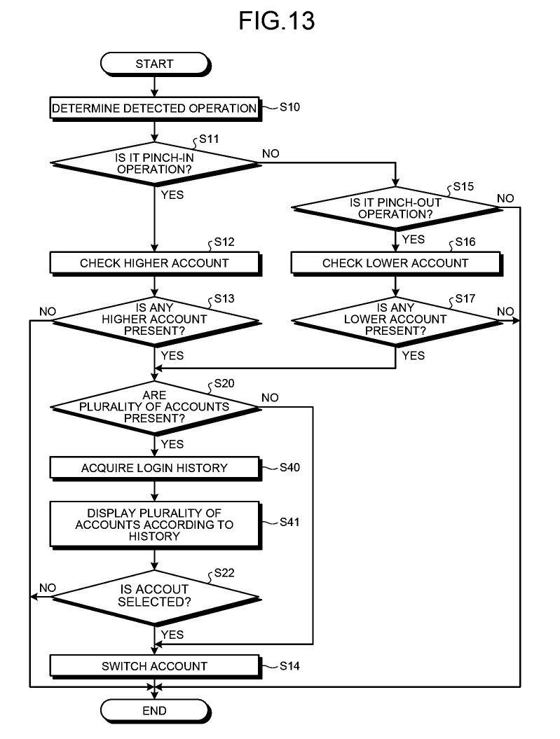

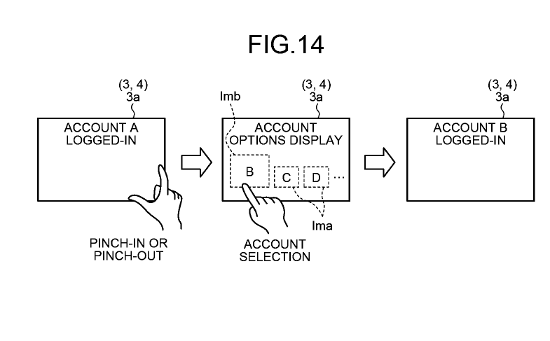

An electronic device 1D according to a fourth embodiment comprises a similar configuration to those of the above-described embodiments, performs similar processing (control), and achieves a similar action and result (effect) based on the similar configuration and similar processing. The present embodiment exemplifies a selection method when a plurality of higher or lower accounts corresponding to a current account are present. Specifically, as illustrated in FIG. 12, in the present embodiment, as an example, the main controller 10 further functions as a history acquisition module 17. As illustrated in FIG. 13, when any higher or lower account corresponding to the current account is present (Yes at S13 or Yes at S17), and when a plurality of further higher or lower accounts are present (Yes at S20), the main controller 10 functions as the history acquisition module 17 and acquires data on a login history for each account stored in the storage module 20 or the external device (S40). The main controller 10 functions as the display controller 14, as illustrated in FIG. 14, and controls the display device 3 so that a plurality of images Ima and Imb corresponding to a plurality of accounts as switching candidates (for example, icons and letters), respectively, are displayed on the display screen 3a (S41). In this S41, as an example, as illustrated in FIG. 14, the image Imb of the account B with a large (the largest) login count or with a long (the longest) time period during which the account has been logged in is displayed in a larger size than the images Ima of the other accounts C and D. In other words, in the present embodiment, as an example, the images corresponding to the accounts are different from each other depending on the respective histories. After this S41, when the operation determination module 13 determines that any one of the images Ima has been selected through an operation (input) by the user (Yes at S22), the account switching module 12 switches the logged-in account from the current account to the account selected at S22 (S14). The present embodiment, therefore, as an example, allows the user to easily select any one of the accounts corresponding to the current account while watching the display screen 3a. Furthermore, in the present embodiment, as an example, account selection is easily performed more smoothly because the image Imb of the account B with large (the largest) login count or long (longest) time period is displayed in a larger size than the images Ima of the other accounts C and D.

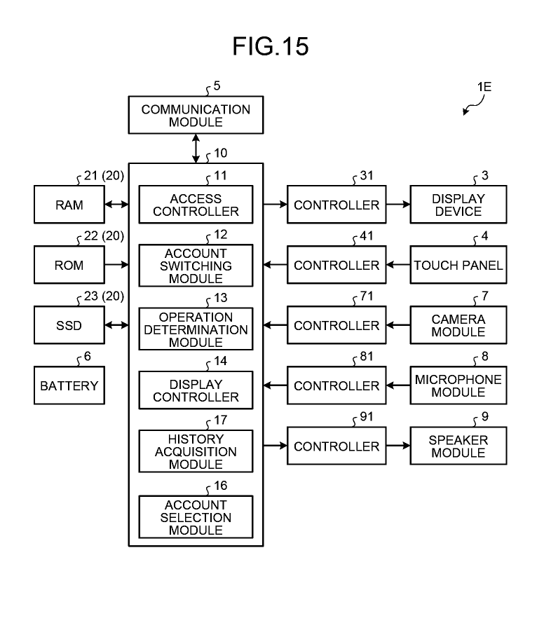

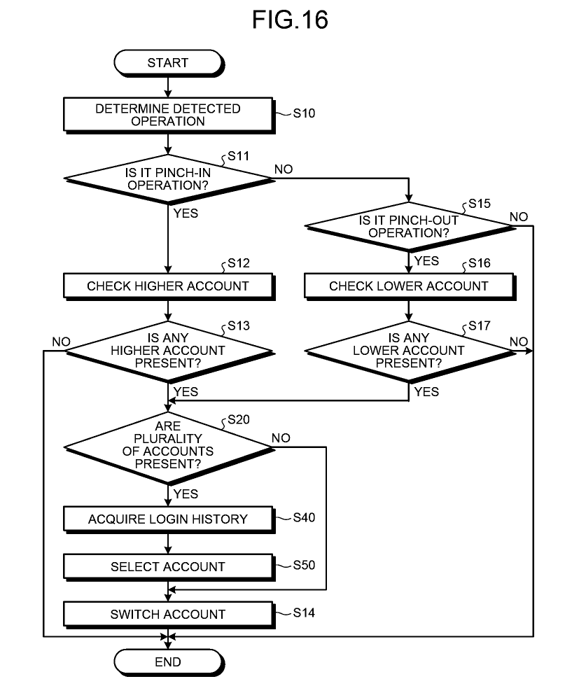

An electronic device 1E according to a fifth embodiment comprises a similar configuration to those of the above-described embodiments, performs similar processing (control), and achieves a similar action and result (effect) based on the similar configuration and similar processing. The present embodiment exemplifies a selection method when a plurality of higher or lower accounts corresponding to a current account are present. Specifically, as illustrated in FIG. 15, in the present embodiment, as an example, the main controller 10 further functions as the account selection module 16 and the history acquisition module 17. As illustrated in FIG. 16, when any higher or lower account corresponding to the current account is present (Yes at S13 or Yes at S17), and when a plurality of further higher or lower accounts are present (Yes at S20), the main controller 10 functions as the history acquisition module 17 and acquires data on a login history for each account stored in the storage module 20 or the external device (S40). Next, the main controller 10 functions as the account selection module 16 and selects, out of the higher or lower accounts corresponding to the current account, an account with a large (largest) login count or a long (longest) time period during which the account has been logged in (S50). Next, the main controller 10 functions as the account switching module 12 and switches the logged-in account from the current account to the selected account (S14). The present embodiment, therefore, as an example, automatically switches logged-in account from the current account to the account with of the large (largest) login count or the long (longest) time period during which the account has been logged in. In addition, the present embodiment, as an example, easily prevents the case in which the logged-in account is switched to a wrong account.

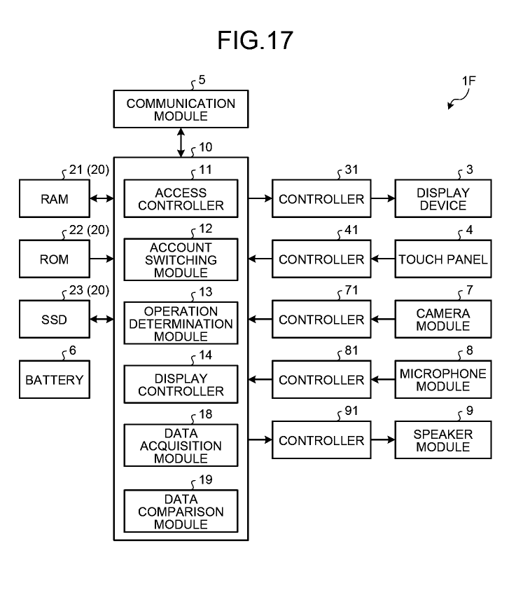

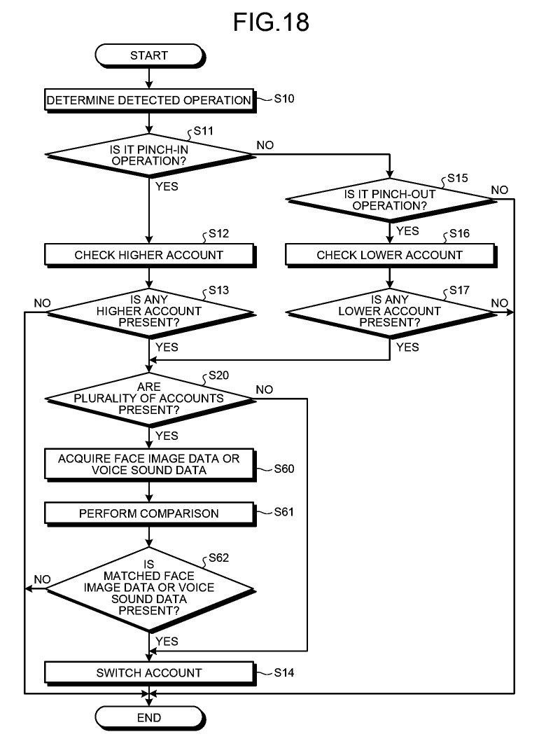

An electronic device 1F according to a sixth embodiment comprises a similar configuration to those of the above-described embodiments, performs similar processing (control), and achieves a similar action and result (effect) based on the similar configuration and similar processing. The present embodiment exemplifies a selection method when a plurality of higher or lower accounts corresponding to a current account are present. Specifically, as illustrated in FIG. 17, in the present embodiment, as an example, the main controller 10 further functions as a data acquisition module 18 and a data comparison module 19. As illustrated in FIG. 18, when any higher or lower account corresponding to the current account is present (Yes at S13 or Yes at S17), and when a plurality of further higher or lower accounts are present (Yes at S20), the main controller 10 functions as the data acquisition module 18 and acquires face image data from the camera module 7 or voice sound data from the microphone module 8 (S60). Next, the main controller 10 functions as the data comparison module 19 and compares a plurality of pieces of face image data or a plurality of pieces of voice sound data for each account (for each account ID) stored in the storage module 20 (as an example, the SSD 23) or the external device with the face image data or the voice sound data acquired by the data acquisition module 18 and identifies an account for which matching of the face image data or the voice sound data occurs (S61). When an account for which matching of the face image data or the voice sound data occurs has been identified in this S61 (Yes at S62), the main controller 10 functions as the account switching module 12 and switches the logged-in account from the current account to the account identified by the data comparison module 19 (S14). In the case of No at S62, the procedure in FIG. 18 is ended. The present embodiment, therefore, as an example, easily prevents the case in which the logged-in account is switched to a wrong account, owing to the comparison of the face image date or the voice sound data.

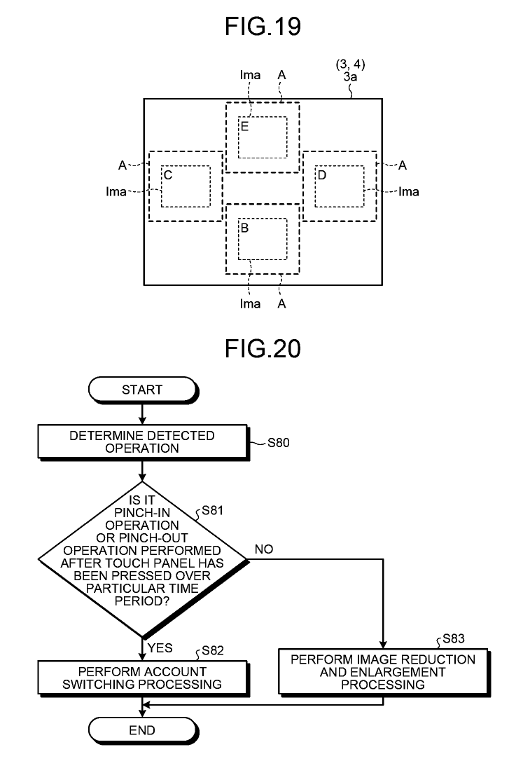

An electronic device according to a seventh embodiment comprises a similar configuration to those of the above-described embodiments, performs similar processing (control), and achieves a similar action and result (effect) based on the similar configuration and similar processing. In the present embodiment, as an example, as illustrated in FIG. 19, a specific area A in which an operation is performed for account switching is set on the touch panel 4 (the display screen 3a). The image in FIG. 19 is an example of an image displayed after the pinch-in operation or pinch-out operation has been started (for example, the image shown at the center of FIG. 11). In the example of FIG. 19, account switching processing is performed when the start or end of the pinch-in operation or pinch-out operation has been detected in each area A that includes the image Ima corresponding to an account and is extended around the image Ima. In this case, the account subjected to switching is switched to an account corresponding to the area A. Also in this case, for a pinch-in operation or pinch-out operation that starts or ends at any position other than the areas A on the touch panel 4 (the display screen 3a), for example, the main controller 10 may perform control to enlarge or reduce a size of the image without performing account switching processing. The present embodiment, therefore, as an example, easily prevents unintentional switching through a pinch-in operation or pinch-out operation. The present embodiment, as an example, allows the pinch-in operation and pinch-out operation for image size reduction and enlargement and the pinch-in operation and pinch-out operation for account switching to be distinguished from each other.

An electronic device according to an eighth embodiment comprises a similar configuration to those of the above-described embodiments, performs similar processing (control), and achieves a similar action and result (effect) based on the similar configuration and similar processing. In the present embodiment, as an example, as illustrated in FIG. 20, the main controller 10 first functions as the operation determination module 13 and determines whether the data corresponding to the detection result on the touch panel 4 corresponds to a pinch-in operation performed after the touch panel has been pressed without position change over a particular time period (for example, 1 second or more) and whether the data corresponds to a pinch-out operation performed after the touch panel has been pressed without position change over a particular time period (S80). When the data corresponding to the detection result on the touch panel 4 corresponds to the pinch-in operation performed after the touch panel has been pressed over the particular time period without the position change or corresponds to the pinch-out operation performed after the touch panel has been pressed over the particular time period without the position change (Yes at S81), the main controller 10 performs account switching processing according to a similar procedure to those of the above-described embodiments (S82). In the case of No at S81, the main controller 10 functions as the display controller 14, and performs reduction of the size of the image displayed on the display screen 3a according to the pinch-in operation and enlargement of the size of the image displayed in the display screen 3a according to the pinch-out operation (S83). The present embodiment, therefore, as an example, allows the pinch-in operation and pinch-out operation for image reduction and enlargement to be distinguished from the pinch-in operation and pinch-out operation for account switching. Any specific operation other than stationary pressing over a particular time period may be applicable. The image may be reduced or enlarged when this specific operation is followed by a pinch-in operation or pinch-out operation.

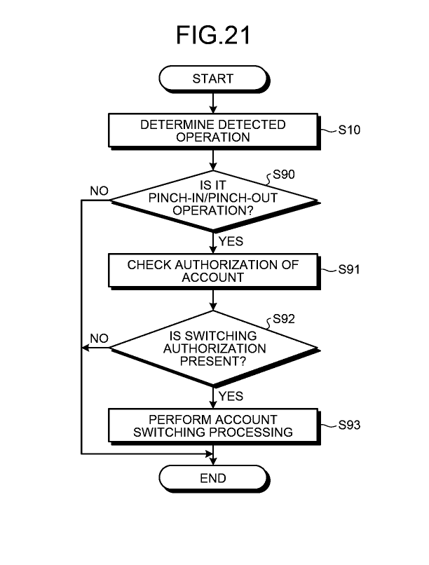

An electronic device according to a ninth embodiment comprises a similar configuration to those of the above-described embodiments, performs similar processing (control), and achieves a similar action and result (effect) based on the similar configuration and similar processing. In the present embodiment, as an example, as illustrated in FIG. 21, the main controller 10 first functions as the operation determination module 13 and determines whether the data corresponding to the detection result on the touch panel 4 corresponds to a pinch-in operation and whether the data corresponds to a pinch-out operation (S90). Next, when the data corresponding to the detection result on the touch panel 4 corresponds to the pinch-in operation or the data corresponds to the pinch-out operation (Yes at S90), the main controller 10 functions as the account switching module 12, and refers to data on authorization stored in the storage module 20 (as an example, the SSD 23) or the external device to check whether the current account has an account switching authorization (S91). When the current account has the account switching authorization (Yes at S92), the main controller 10 functions as the account switching module 12 and performs account switching processing according to a similar procedure to those of the above-described embodiments (S93). In the case of No at S90, and in the case of No at S92, the procedure in FIG. 21 is ended. The present embodiment, therefore, as an example, allows to limit the logged-in account to be switched to a higher account or to a lower account.

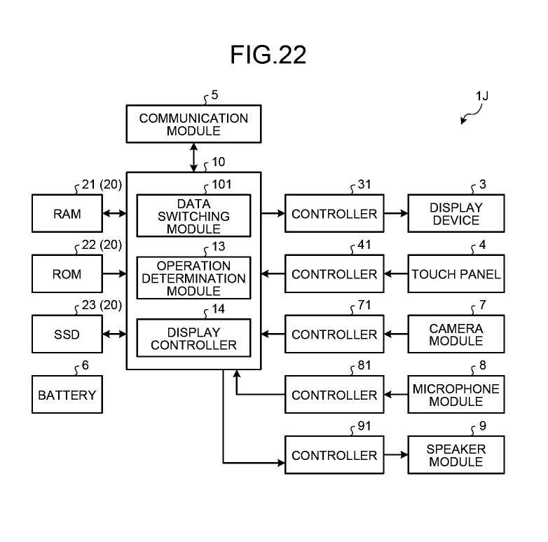

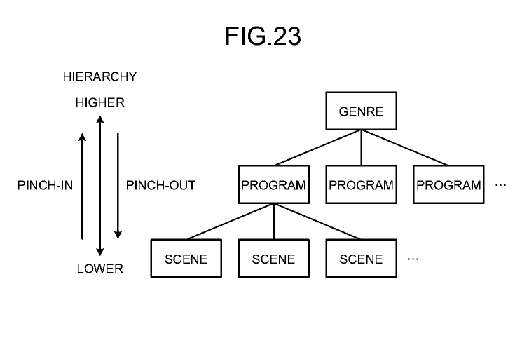

In an electronic device 1J according to a tenth embodiment (see FIG. 22), it is assumed that a hierarchy (master-slave relation, dependency, inclusion, or category) of a plurality of pieces of data in which a plurality of pieces of data (content, documents, images, or the like) are hierarchically associated is set as illustrated in FIG. 23. FIG. 23 illustrates, as an example, a hierarchy of data on Web pages (for example, Hyper Text Markup Language (HTML) documents) related to moving image contents (programs) of TV broadcasting or the like: the data in the high level (large category) is data on the top page of a genre; the data in the next lower level (smaller category) is data on the top pages of programs; and the data in the further lower level (further smaller category) is data on pages or moving images indicating recommended scenes in the respective programs. The hierarchy of a plurality of pieces of data may be set in various manners. Data indicating the hierarchy of a plurality of pieces of data (for example, the uniform resource locator (URL) of a Web page, an IP address, or an identifier) is stored in the storage module 20 (for example, the SSD 23), the external device (administrative server), or the like.

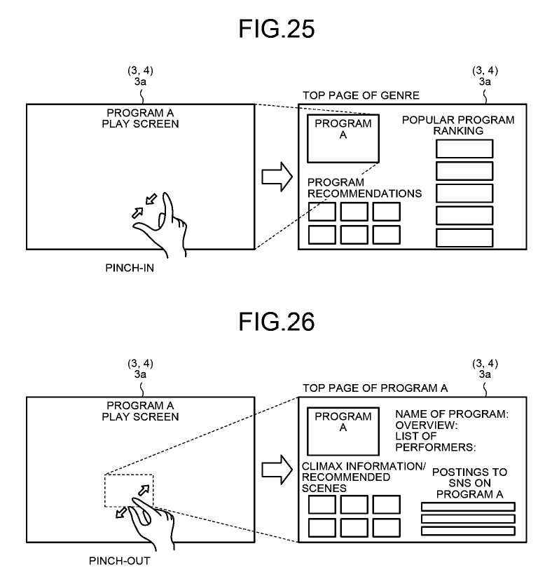

Also in the present embodiment, as an example, as illustrated in FIGS. 25 and 26, switching from the lower page to the higher page is performed by the pinch-in operation (input) onto the touch panel 4, and switching from the higher page to the lower page is performed by the pinch-out operation (input) onto the touch panel 4. FIG. 25 illustrates an example where a screen in which a program A is being played shifts to the top page of the genre in which the program A is included through the pinch-in operation. FIG. 26 illustrates an example in which the screen in which the program A is being played shifts to the top page of the program A indicating the detailed information of the program A through the pinch-out operation. In one possible setting, performing a pinch-out operation with the top page of the genre displayed on the right-hand side of FIG. 25 allows shift to the state in which the top page of the program A on the right-hand side of FIG. 26 is displayed. In another possible setting, performing a pinch-in operation with the top page of the program A displayed on the right-hand side of FIG. 26 allows shift to the state in which the top page of the genre on the right-hand side of FIG. 25 is displayed.

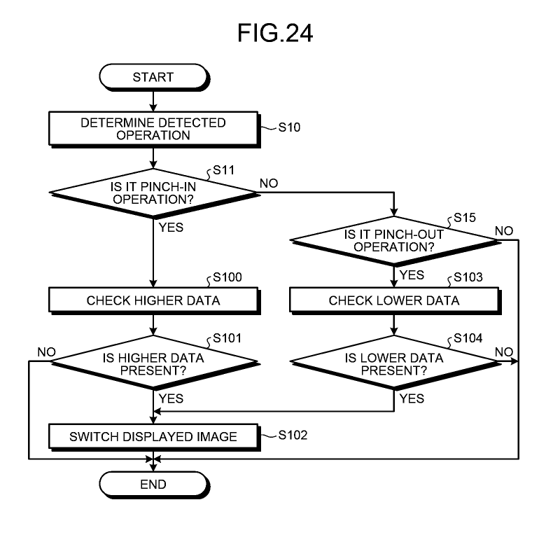

As illustrated in FIG. 22, as an example, except that the main controller 10 comprises a data switching module 101 in place of the account switching module 12, the present embodiment comprises a similar configuration to those of the above-described embodiments, performs similar processing (control), and achieves a similar action and result (effect) based on the similar configuration and the similar processing. As illustrated in FIG. 24, in the present embodiment, as an example, when the change in the two detection positions is one corresponding to the pinch-in operation at S11 (Yes at S11), the main controller 10 functions as the data switching module 101 and checks the presence or absence of higher data corresponding to the current data (the data displayed on the display screen 3a) in the storage module 20 or the external device (S100). To the external device, the data switching module 101 makes an inquiry of the presence or absence of the data. When the higher data is present at S100 (Yes at S101), the main controller 10 functions as the data switching module 101 and switches the image (data) displayed on the display screen 3a from the current data to the corresponding higher data (S102).

When the change in the two detection positions does not correspond to the pinch-in operation at S11 (No at S11) but corresponds to the pinch-out operation (Yes at S15), the main controller 10 functions as the data switching module 101 and checks the presence or absence of any lower account corresponding to the current account in the storage module 20 or the external device (S103). When the lower account is present at S103 (Yes at S104), the main controller 10 functions as the data switching module 101 and switches the image displayed on the display screen 3a from the current data to the corresponding lower data (S102). In the case of No at S101, and in the case of No at S104, the procedure in FIG. 24 is ended.

As described above, the present embodiment, as an example, provides setting in which a plurality of pieces of data are associated hierarchically, thereby allowing the image displayed on the display screen 3a to be switched through the pinch-in operation or pinch-out operation. The configurations and procedures disclosed in the above-described embodiments may be applied similarly to the present embodiment.

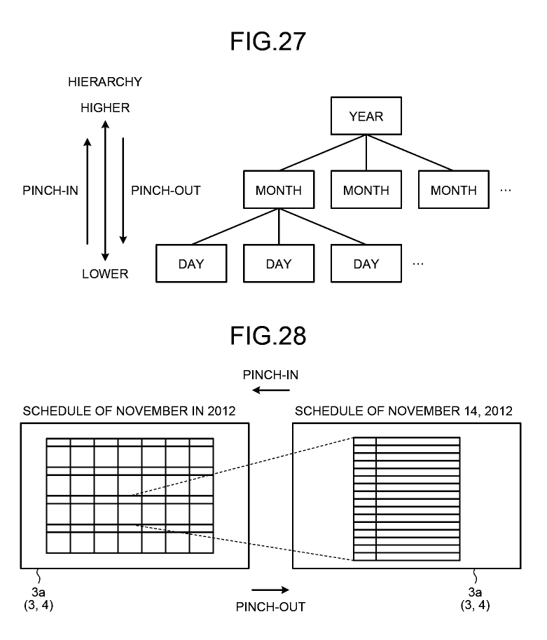

In an electronic device according to a first modification of the tenth embodiment, as an example, it is assumed that a hierarchy (master-slave relation, dependency, inclusion, or category) of a plurality of pieces of data in which a plurality of pieces of data (documents, images, window data or the like) are hierarchically associated is set as illustrated in FIG. 27. FIG. 27 illustrates, as an example, a hierarchy of data on schedule management software: the data in the high level (large category) is data on a yearly schedule window; the data in the next lower level (smaller category) is data on a monthly schedule window; and the data in the further lower level (further smaller category) is data on a daily schedule window. The hierarchy of a plurality of pieces of data may be set in various manners. Data indicating the hierarchy of a plurality of pieces of data (as an example, a window identifier) is stored in the storage module 20 (for example, the SSD 23), the external device (administrative server), or the like.

Also in the present modification, as an example, as illustrated in FIG. 28, switching from the lower page to the higher page is performed by the pinch-in operation (input) onto the touch panel 4, and switching from the higher page to the lower page is performed by the pinch-out operation (input) onto the touch panel 4. FIG. 28 illustrates an example in which the monthly schedule window switches to the daily schedule window through the pinch-out operation, and the daily schedule window switches to the monthly schedule window through the pinch-in operation.

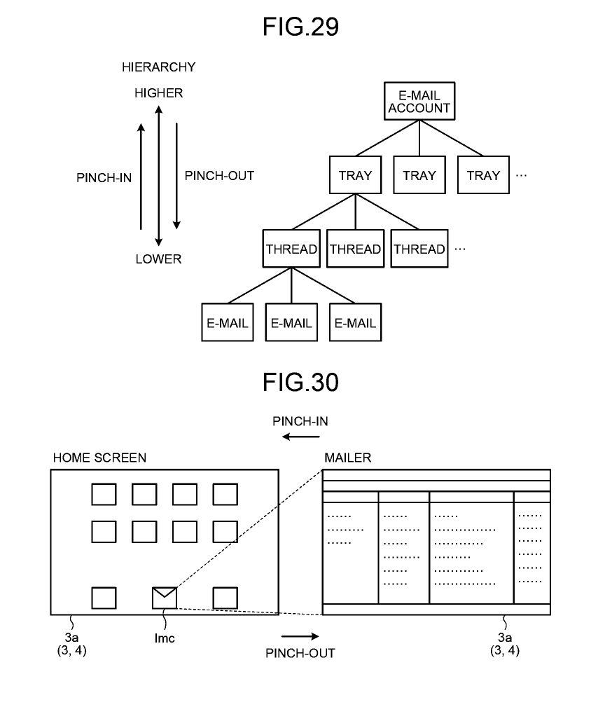

In an electronic device according to a second modification of the tenth embodiment, as an example, it is assumed that a hierarchy (master-slave relation, dependency, inclusion, or category) of a plurality of pieces of data in which a plurality of pieces of data (documents, images, window data or the like) are hierarchically associated is set as illustrated in FIG. 29. FIG. 29 illustrates, as an example, a hierarchy of data on mail software (mailer): the data in the high level (large category) is data on the top page of a mail account; the data in the next lower level (smaller category) is data on the windows of trays (boxes, folders, for example, an in-tray or an out-tray); the data in the further lower level (further smaller category) is data on threads (groups); and the data in the still further lower level (still further smaller category) is data on e-mails. The hierarchy of a plurality of pieces of data may be set in various manners. Data indicating the hierarchy of a plurality of pieces of data (as an example, a window identifier) is stored in the storage module 20 (for example, the SSD 23), the external device (administrative server), or the like.

Also in the present modification, as an example, as illustrated in FIG. 30, switching from the lower page to the higher page is performed by the pinch-in operation (input) onto the touch panel 4, and switching from the higher page to the lower page is performed by the pinch-out operation (input) onto the touch panel 4. FIG. 30 illustrates an example in which the pinch-out operation on the home screen of the electronic device on which an image Imc (icon) of the mailer is displayed in the vicinity of the image Imc allows shift from the home screen to the top page of the mail account of the mailer, and the pinch-in operation allows shift from the top page of the mail account of the mailer to the home screen of the electronic device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display device comprising a display screen;
a touch sensor configured to detect an operation on a display screen side of the display device;
an account switching module configured to switch a logged-in account from a second account which is lower than a first account to the first account when a detection result of the touch sensor corresponds to a pinch-in operation, and to switch the logged-in account from the first account to the second account when the detection result of the touch sensor corresponds to a pinch-out operation; and
a display controller configured to control the display device so as to display an image on the display screen.

2. The electronic device of claim 1, wherein the display controller is configured to control, when the logged-in account is switched from the second account to the first account in accordance with the pinch-in operation, the display device so as to reduce a size of at least a portion of an image displayed at a time when the second account is logged in.

3. The electronic device of claim 1, wherein the display controller is configured to control, when the logged-in account is switched from the first account to the second account in accordance with the pinch-out operation, the display device so as to enlarge a size of at least a portion of an image displayed at a time when the first account is logged in.

4. The electronic device of claim 1, further comprising:
a detection position acquisition module configured to acquire a detection position of the pinch-in operation or the pinch-out operation; and
an account selection module configured to select one of a plurality of accounts from positions of a plurality of images corresponding to the accounts, respectively, displayed on the display screen and from the detection position detected by the detection position acquisition module, wherein
the account switching module is configured to switch the logged-in account to the one of the accounts selected by the account selection module.

5. The electronic device of claim 1, further comprising an account selection module configured to acquire stored data on a login history for each of a plurality of accounts, and to select one of the accounts with a large login count or along time period during which the account has been logged in, wherein
the account switching module is configured to switch the logged-in account to the one of the accounts selected by the account selection module.

6. The electronic device of claim 1, further comprising:
a data acquisition module configured to acquire image data or sound data; and
a data comparison module configured to compare face image data acquired by the data acquisition module with face image data stored in association with an account ID or to compare voice sound data acquired by the data acquisition module with voice sound data stored in association with the account ID, to specify one of a plurality of accounts corresponding to the acquired face image data or the acquired voice sound data, wherein
the account switching module switches the logged-in account to the one of the accounts specified by the data comparison module.

7. The electronic device of claim 1, wherein the account switching module is configured to switch the logged-in account when the pinch-in operation or the pinch-out operation is data detected in a specific area of the touch sensor.

8. The electronic device of claim 1, wherein the account switching module is configured to switch the logged-in account when the detection result on the touch sensor corresponds to the pinch-in operation or the pinch-out operation following a specific operation.

9. The electronic device comprising:
a display device comprising a display screen;
a touch sensor configured to detect an operation on a display screen side of the display device; and
a display controller configured to control the display device so as to switch an image displayed on the display screen from an image corresponding to first data to an image corresponding to at least one of a plurality of pieces of second data associated with the first data when a detection result of the touch sensor corresponds to a pinch-out operation, and to control the display device so as to switch the image displayed on the display screen from the image corresponding to the at least one of the pieces of the second data to the image corresponding to the first data.

10. A computer program product having a non-transitory computer readable medium including programmed instructions for a controller of an electronic device comprising a display device comprising a display screen, a touch sensor configured to detect an operation on a display screen side of the display device, wherein the instructions, when executed by a computer, cause the computer to perform:
switching a logged-in account from a second account which is lower than a first account to the first account when a detection result of the touch sensor corresponds to a pinch-in operation, and from the first account to the second account when the detection result of the touch sensor corresponds to a pinch-out operation; and
controlling the display device so as to display an image on the display screen.
